(19) United States
(12) Patent Application Publication
(10) Pub. No.: US 2026/0219815 A1
(43) Pub. Date: Jul. 30, 2026

(54) Method for Local Printing

(71) Applicants: Kerstin Horst, Bochum (DE); Matthias Horst, Bochum (DE); Thomas Pempelforth, Krefeld (DE); Bernd Clas, Konstanz (DE)

(72) Inventors: Kerstin Horst, Bochum (DE); Matthias Horst, Bochum (DE); Thomas Pempelforth, Krefeld (DE); Bernd Clas, Konstanz (DE)

(73) Assignee: Genius Bytes Software Solutions GmbH, Bochum (DE)

(21) Appl. No.: 19/451,545

(22) Filed: Jan. 16, 2026

(30) Foreign Application Priority Data
Jan. 24, 2025 (EP) 25153799.9

(51) Int. Cl. G06F 3/12

(52) U.S. Cl. CPC G06F 3/1231; G06F 3/1222; G06F 3/1236; G06F 3/1238; G06F 3/1289; G06F 3/1292

(57) ABSTRACT

A method for local printing, in particular, during a TCP/IP-based data connection established with a background system and a background system and a printing system with a background system.

### CROSS-REFERENCE TO RELATED PATENT APPLICATION

This patent application claims the benefit of priority to European Patent Application No. 25153799.9 filed Jan. 24, 2025, the entire teachings and disclosures of which are incorporated herein by reference thereto.

### FIELD OF THE INVENTION

The invention relates to a method for local printing, in particular, during a TCP/IP-based data connection established with a background system. In addition, the invention relates to a background system and a printing system with a background system.

### BACKGROUND OF THE INVENTION

From the prior art, methods for operating printing systems with at least one printer are known, which can be used by at least one computer and computer device, respectively, to print a print job.

A computer may comprise a printer respectively may be connected to a printer. An application installed on the computer and executable by a processor can be operated by a user by means of a user interface. For example, a print job can be generated and/or selected by the application. The generated print job can be transmitted from the computer to the printer of the computer so that this job is printed by the printer in a known manner.

Nowadays, people are increasingly working from home and/or a user is at a customer with his/her mobile computer (and local printer). For security reasons it is, in particular, common practice for a (software) application that it is installed on a (central) background system and executed by at least one processor of the background system, for example, to be operated by a user working from home and/or at a customer's premises. A so-called local computer located geographically remote from the background system can be connected to the background system via a TCP/IP-based data connection over a public data network (in particular, the Internet). For example, a corresponding data connection between the local computer and the background system can be established via the public data network in such a way that the at least one background application of the background system can be operated by the at least one user interface of the local computer. This can also be referred to as a remote desktop session. In particular, the TCP/IP-based data connection cannot be respectively include a tunnel connection.

In the case of a TCP/IP-based data connection, a plurality of background applications respectively background application programs can be executed on at least one data processing device of the background system (also referred to as a server respectively server system) and displayed on and operated by a local computer (also referred to as a client) located geographically remote from the background system. In particular, only display data and operating data are exchanged via the data connection, in particular, without documents and the like being transmitted via the established data connection. In contrast to screen sharing, for example, no user has to log in locally to the background system.

During an established remote desktop session, i.e., during an established and previously described data connection between the local computer and the background system, this session runs independently of any other remote desktop session that may be running between this background system and a further local computer. In other words, a plurality of local computers located geographically remote from the background system can be connected to the background system simultaneously via respective TCP/IP-based data connections in order to enable, in particular, a plurality of background applications of the background system to be operated by means of the respective local computer respectively the respective user interfaces.

However, a problem with such a printing system of the prior art comprising a background system and at least one local computer is the printing of print jobs that may be stored, in particular, in a print job data memory of the background system. In particular, a security module of the background system prevents the print job from being transmitted to a local printer of the local computer via the established TCP/IP-based data connection.

One possibility to print the print job stored in the background system is to use a printer of the background system that is directly connected to the at least one data processing device of the background system. However, the disadvantage of this solution is that this printer is located at the location of the background system (e.g., in an office building) and is therefore geographically distant from the local computer of the user (which may, for example, be located in a residential building). The user cannot therefore access the printed print job until he/she is back at the location of the background system, i.e., in the office building (and thus no longer in the home office and/or at a customer's premises).

However, it is often desirable that a print job that is available respectively stored in the background system is printed by a local printer connected to the local computer, in particular, to enable the user (who is in his/her home office and/or at a customer's premises) to access the printed print job immediately. However, as described above, direct transmitting of the print job via the established TCP/IP-based data connection is not possible due to the security settings respectively security modules that are usually provided. In order to enable local printing nonetheless, a tunnel, i.e., an encapsulated transmission path, can be established between the local computer and the background system. However, this may, for example, not be possible at a customer's premises or may only be possible at great expense.

A further workaround for the problem that a local printing is not possible for a user is to send an email with the print job (e.g., as an attachment) from a first (e.g., business) email account (or similar) to a second (e.g., private) email account (or similar) of the user. The user can then open the second email account on the local computer independently of the TCP/IP-based data connection and initiate printing of the print job by the connected local printer in the usual manner. However, this procedure is not only time-consuming, but also problematic for security reasons, as the print job is transmitted via an unsecured connection. There is therefore a risk that unauthorized third parties may gain knowledge of the print job.

### SUMMARY OF THE INVENTION

Therefore, it is the object of the invention to provide a possibility that allows a user-friendly and at the same time secure printing by means of a local printer of a local computer that is located remotely from the background system in the case of a TCP/IP-based data connection.

According to a first aspect of the invention, the object is solved by a (computer-implemented) method according to claim 1. The method is used for local printing of a print job, in particular, during a (established) remote desktop session. The method comprises:
providing at least one local computer comprising at least one local printer, at least one user interface, and a print job router with a unique router identifier,
providing a background system comprising at least one print job data memory, wherein at least a part of the print jobs stored in the print job data memory are each assigned a user identifier,
establishing a TCP/IP-based data connection between the local computer and the background system via a data network, wherein the background system is configured to store an assignment between the established TCP/IP-based data connection and the router identifier transmitted via the established TCP/IP-based data connection,
providing, by the local computer, of at least the router identifier such that at least the router identifier is detectable by a mobile terminal of a user,
receiving, by the background system from the mobile terminal, an authentication data set containing at least one user identifier of the user of the mobile terminal,
performing, by the background system, an authentication check at least on the basis of the received user identifier,
receiving, by the background system from the mobile terminal, at least the router identifier,
transmitting, by the background system to the mobile terminal, a print job data set containing at least one print job assigned to the received user identifier, (only) after successful authentication,
receiving, by the background system from the mobile terminal, at least one print job to be printed selected from the transmitted print job data set, and
transmitting, by the background system to the local computer, the at least one print job to be printed via the established TCP/IP-based data connection based on the received router identifier in such a way that the at least one print job to be printed is printable by the local printer.

By transmitting, in contrast to the prior art and according to the invention, by means of a mobile terminal (in particular, in the form of a smartphone, tablet, and/or the like) a router identifier provided by the local computer (for example, by the print job router) and transmitted to the background system by means of at least one further data connection (between the background system and the mobile terminal), wherein a secure and simple user authentication can be performed via this additional data connection, a possibility is provided which, in the case of a TCP/IP-based data connection (without a tunnel), allows a user-friendly and at the same time secure printing by a local printer of a local computer located remotely from the background system. In other words, a user (in a home office and/or at a customer's premises) is given secure, immediate access to a locally printed print job that is, for example, generated in the background system and, in particular, stored there.

The method is, in particular, intended for use in and during, respectively, an established TCP/IP-based data connection, for example, during a remote desktop session without a tunnel, between a local computer and a remotely located background system. According to the invention, at least one local computer (of a user) and one background system located geographically remote from the at least one local computer are provided. Preferably, a plurality of local computers and a central background system can be provided.

A local computer can preferably be a stationary workstation computer. In variants of the invention, the local computer may also be a mobile, in particular, portable, local computer, such as a laptop, smartphone, tablet computer, and/or the like. This can be used, for example, at a customer's premises. A local computer comprises at least one processor and storage means for storing at least one computer program that can be executed by the processor.

A local computer may comprise at least one user interface, preferably a plurality of (different) user interfaces. A user interface is configured to interact with a user. A user interface may be configured to output data/information and/or to input data/information. For example, the at least one user interface may be an optical display (e.g., in the form of a screen), a loudspeaker, a microphone, a keyboard, a mouse, a touch display, and/or the like.

In addition, the at least one local computer comprises at least one local (stationary or mobile) printer. This means, in particular, that there is a (wireless and/or wired) communication connection (e.g., a local area network (LAN), wireless LAN (WLAN), Bluetooth, etc.) between the local computer and the at least one local printer, i.e., the local printer is connected to the local computer. In this context, a local printer of a local computer is understood to be a printer that is connected to the computer and is located in a predefined (physical) proximity, for example, in the same building, at least closer than 10 m to the local computer, preferably at least closer than 5 m, and/or preferably in the same room as the local computer.

A local printer comprises at least one printing function, for example, in the form of a print module. The print module is configured in a conventional manner to print a print job, in particular, on a printable medium (e.g., paper). Additional functions, such as a scanner function and/or a fax function, may be implemented in a local printer.

A mobile terminal is, in particular, a smartphone and/or tablet (in particular, with a mobile radio module) that differs from the local computer.

The background system (also referred to as the backend system) can be formed by one or more (distributed) data processing devices, for example, in the form of one or more servers. For example, the background system can be formed by a cloud system. A data processing device may, in particular, comprise at least one processor. The processor may, for example, be configured to execute at least one background application in the form of a computer program respectively executable software modules stored in a storage means of the background system.

The method comprises the establishing of a TCP/IP-based data connection between the background system (in particular, the at least one data processing device and/or the print job data memory of the background system) and the at least one local computer (in a conventional manner). In particular, a TCP/IP-based data connection for a remote desktop session between the local computer and the background system can be established in a known manner via the Internet.

For example, a TCP/IP-based data connection is established in such a way that at least one background application of the background system can be operated and, in particular, displayed by the at least one user interface of the local computer. For example, a background application (e.g., a word processing program, image processing program, spreadsheet program, printing program, etc.) can be configured to create a document (e.g., text, spreadsheet, image, etc.) and/or to create a print job. In particular, the background application can be displayed on a screen of the local computer and operated by a user, for example, via a keyboard, mouse, etc. of the local computer.

According to the invention, the local computer comprises a print job router, in particular, in the form of a software module that can be executed by a processor and which is installed on the computer. The print job router can be configured to forward a print job received (from the background system) to the local printer, which can, for example, be assigned a printer identifier (unique to the print job router). The printer identifier can be a unique code and/or a unique (network) address of the local printer.

The print job router is assigned a router identifier that is unique (across the entire printing system).

The background system is configured to assign and (temporarily) store the assignment (e.g., in a corresponding database of the background system) between the established TCP/IP-based data connection and the router identifier transmitted to the background system by the local computer via the established TCP/IP-based data connection. In particular, the background system knows the assigned router identifier (if available) for an established TCP/IP-based data connection.

Furthermore, a (system-wide unique) user identifier is assigned to the user of the local computer and the mobile terminal. This can be stored (permanently) in the mobile terminal respectively assigned to it. Preferably, existing user identifiers such as an Apple identifier, Google identifier, or similar can be used.

The background system comprises at least one print job data memory configured to store print jobs. At least one (previously mentioned) user identifier is assigned to a part of the print jobs, preferably to all stored print jobs. This ensures that a print job can only be printed by the at least one authorized user assigned to that print job.

The print job router is, in particular, configured to provide the router identifier in such a way that it is detectable by a mobile terminal. A providing of the router identifier, in particular, to the local computer, means, in particular, that a mobile terminal can only receive this router identifier if it (and thus the user holding respectively carrying the mobile terminal) is in close (physical) proximity (e.g., at least closer than 5 m, preferably at least closer than 1 m, and/or preferably in the room in which the local computer is located). This reduces the risk of an unauthorized third party receiving the router identifier without authorization.

The background system receives, in particular, via a further data connection (in particular, at least partially a mobile radio connection), an authentication data set containing at least the user identifier of the user of the mobile terminal from the mobile terminal. In particular, the user can authenticate himself/herself on his mobile terminal in the conventional manner, for example, by means of biometric verification (e.g., fingerprint, facial recognition, etc.), as is common with Apple identifier, Google identifier, etc. This user identifier (e.g., Apple identifier, Google identifier), which has already been verified, can be used for authentication on respectively at the background system.

In particular, an authentication module of the background system can perform an authentication based on this user identifier (in a known manner).

Furthermore, the mobile terminal can transmit the detected router identifier to the background system, for example, together with the user identifier, but also separately from it. This ensures that the background system now has knowledge of the user of the local computer and can thus, in particular, drive respectively control it.

In particular, only after successful respectively positive authentication, i.e., if it is determined that the user is authorized, it can be determined by the background system that the at least one stored print job that is assigned to the received user identifier. If no positive authentication takes place and it is determined that the user is not authorized, such a providing does not take place. This at least one print job, in particular, a plurality of print jobs, can be transmitted by the background system to the mobile terminal, in particular, in the form of a print job data set. For example, the mobile terminal can display the at least one available print job to the user by means of a display.

According to the invention, the background system then receives from this mobile terminal at least one print job (to be printed) (for example, a print job identifier of the print job) selected from the transmitted print job data set. In particular, the user can determine one or more print jobs to be printed locally by means of a user action detectable on the mobile terminal.

According to the invention, the at least one print job of the user is transmitted via the established TCP/IP-based data connection based on the received router identifier in such a way that the at least one print job to be printed is printable by the local printer. In particular, the background system uses the router identifier received from the mobile terminal to determine the TCP/IP-based data connection assigned to this router identifier from the stored assignments between TCP/IP-based data connections and router identifiers. The background system then transmits the at least one selected print job to the local computer via the determined TCP/IP-based data connection. This computer respectively the corresponding print job router forwards the print job to the local printer for local printing. If necessary, the print job can be converted into a suitable print file format, for example, by the print job router and/or the printer.

In principle, the providing of the router identifier by the print job router can be caused in any manner, in particular, in the form of a transmitting of the router identifier, as long as it is ensured that the mobile terminal is located at the local computer in order to receive it. This can further increase security.

According to a preferred embodiment of the method according to the invention, the providing of the router identifier by the local computer, in particular, by the print job router, may comprise causing a displaying of an optical printer code containing the router identifier by a user interface in the form of an optical display of the local computer. In particular, a screen of the local computer can display the optical printer code. The optical printer code can preferably contain the router identifier. By displaying the router identifier in coded form, security can be increased in a simple manner.

According to a particularly preferred embodiment, the optical printer code can be a barcode, such as a QR code, 2D barcode, and/or the like.

The optical printer code can be detected by an optical detection module of the mobile terminal. In particular, the optical detection module can be a camera (with a software image evaluation module executable by a processor of the terminal). In order to detect the printer code, it is particularly necessary for the mobile terminal to be in close proximity (e.g., less than 5 m, preferably less than 1 m) to the local computer respectively the screen of the local computer.

Preferably, the router identifier can be extracted from the printer code (by the mobile terminal). In particular, the router identifier extracted from the optical printer code can be stored in a (secure) data storage of the mobile terminal. For example, the router identifier can be stored in an encrypted form in the data storage of the mobile terminal.

Alternatively or additionally, the router identifier can be transmitted via a near-field communication connection establishable between the mobile terminal and the local computer. Non-exhaustive examples of a near-field communication connection are an RFID connection, an NFC connection, and a Bluetooth connection. In other variants, a wired transmission may also be used.

According to a further embodiment of the method according to the invention, the router identifier may be contained in the authentication data set. In other words, a common data set can be received by the background system containing at least the user identifier and the router identifier.

According to a further embodiment of the method according to the invention, the print jobs (generated, in particular, in respectively by the background system) can be stored in a print job memory of the background system, as has been described. Preferably, only a central print job management equipment of the background system can access the print job memory. In particular, this equipment can process the received data and control/coordinate the method.

As has already been described, a background system can be formed by a plurality of (distributed) data processing devices. One of the plurality of data processing devices can be configured, in particular, as a (secure) print job memory. Preferably, the print jobs can be stored in an encrypted form in a print job memory respectively print job data memory.

In addition, it can be provided that only one defined further data processing device in the form of a print job management equipment can access the print job memory. In particular, there may be only a single data connection to the print job memory, which is provided between the print job memory and the print job management equipment. The print job management equipment may be configured to transmit a generated print job to the print job memory, in particular, to cause a temporary storing of the print job in the print job memory.

Alternatively, or preferably additionally, the print job management equipment may be configured to receive a print data set from a user, in particular, to cause (as described above) a transmitting of the print job of the user to the print job router via the established TCP/IP-based data connection. In particular, upon receipt by the print job management equipment of a print data set respectively the at least one print job to be printed, a request containing at least the user identifier may be generated and transmitted by the print job management equipment to the print job memory. In response, the print job memory sends back to the print job management equipment the at least one print job assigned to this user identifier. If necessary, the print job management equipment can decrypt the received encrypted print job. The at least one (possibly decrypted) print job can then be transmitted, as has been described. A high level of security can be provided.

In particular, in the print job management equipment a list can be stored containing at least the (preferably all) user identifiers of the print jobs (currently) stored in the print job memory. In particular, this allows the print job management equipment to easily provide information about the currently stored print jobs when an information request is received and/or to directly check whether a corresponding print job exists for this user when a print data set is received. The processing time and the amount of data to be exchanged between the print job management equipment and the print job memory can be reduced.

According to a further embodiment of the method according to the invention, the TCP/IP-based data connection can be established between the local computer and the (central) print job management equipment of the background system. In particular, in the case of a plurality of local computers, each corresponding TCP/IP-based data connection can be established (only) with the (central) print job management equipment. The authentication data set and/or the router identifier can be received by the print job management equipment. In other words, the at least one mobile terminal can (via the respective at least one further data connection) only exchange data with the (central) print job management equipment. Preferably, the transmitting of the at least one print job of the user can be controlled by the print job management equipment, as has, in particular, been described.

According to a preferred embodiment of the method according to the invention, at least one local printer can be selected from a plurality of (available) local printers of the local computer before the router identifier is provided by the local computer. In particular, the printer identifier of the selected printer can be stored in the print job router. When the local computer receives the at least one print job to be printed, the print job to be printed can be routed by the print job router to the local printer whose printer identifier is stored. In particular, this can further simplify local printing with a plurality of possible local printers of the local computer.

According to a preferred embodiment of the method according to the invention, a plurality of local printers, each with different printer properties, can be connected to the at least one local computer, as has been described. In particular, a first local printer (which, for example, enables printing with a first color data set (e.g., black and white only)) and a second local printer (which, for example, enables printing with a second color data set (e.g., color) that differs from the first color data set) can be connected to the same local computer. The at least two local printers may differ, in particular, in a printing function respectively printer property. Each of the at least two local printers may be assigned a respective printer identifier. In other words, the respective local printer is uniquely identifiable by means of the respective printer identifier.

The print job router can provide the printer identifier of the local printer selected from the plurality of local printers by means of a user interface (of the local computer) in such a way that the printer can be selected. In particular, the print job router can be configured to detect all local printers connected to the local computer. Furthermore, the print job router can be configured, in particular, upon receipt of a corresponding request (e.g., based on a user input), to cause the connected local printers to be displayed on an optical display of the local computer. In particular, the displayed connected local printers can be selectable by user action by means of a user interface. Upon detection of a corresponding user action by the print job router, the corresponding assignment can be stored by the print job router and used, in particular, upon receipt of a print job by the background system, as has been described above.

According to a further embodiment of the method according to the invention, the method may further comprise:
restricting access to the background system, at least to the print job memory (respectively the print jobs stored therein), by at least one security module implemented in the background system, and/or
restricting access to the local computer (respectively the data stored therein) by at least one security module implemented in the local computer.

Preferably, the at least one security module of the background system and/or the local computer can be a firewall module. A firewall module can be used to control the data flow to and from the background system respectively to and from the local computer.

As has already been described, according to a further embodiment of the method according to the invention, the at least one print job of the user can be generated by the at least one background application. The at least one background application can, in particular, be a web printing application. A generated print job can be stored in the print job memory by the print job management equipment, as has been described.

Preferably, the generating of the print job can comprise an assigning of a user identifier to the print job. In particular, the user identifier of the user who caused the print job to be generated can be assigned to a generated print job.

According to a preferred embodiment of the method according to the invention, the method may further comprise:
providing a user print authorization database containing a plurality of user identifiers, wherein each user identifier is assigned at least one user print authorization date regarding the authorization for local printing, and
wherein transmitting the at least one print job of the user via the established TCP/IP-based data connection is further based on the at least one user print authorization date assigned to the user identifier of the user.

A user print authorization date can at least indicate whether the user (who is fundamentally authorized to use the background system) is authorized to print locally or not. Preferably, the at least one user print authorization date can additionally specify which print job categories are approved for local printing for the corresponding user. For example, it can be specified that only certain types of print jobs may be printed locally by a user. Alternatively or additionally, the at least one user printing authorization date can specify whether a print job must be approved by a predefined user (e.g., a supervisor of the user who wants to print a print job locally) before local printing. In this case, a corresponding request can be sent to the supervisor (e.g., to the mobile terminal of the supervisor). Only upon receiving an approval message in response to this request a transmitting of the print job can be performed, as described above. Otherwise (i.e., if no response or a blocking response is received), the transmitting of the print job can be blocked.

In further variants of the invention, additional and/or other specifications can be specified by the at least one user print authorization date.

In particular, at least one user print authorization date can be assigned to each user of the background system.

The background system, in particular, the print job management equipment, can first check the user print authorization date of the user whose print job is to be transmitted for local printing before transmitting the print job. If during the checking, e.g., by a check module of the background system, it is determined that the user print authorization date of the user specifies that local printing of the requested print job is not permitted, transmitting of the print job is blocked. If during the checking by the check module of the background system it is determined that the user print authorization date of the user specifies that local printing of the requested print job is permitted, the print job is transmitted and executed.

As has already been described, in order to enable a user to select a print job to be printed locally, a print job data set containing all print jobs, i.e., in particular, the print jobs (currently) stored in the print job memory, of the user can preferably be transmitted to the mobile terminal of the user (based, in particular, on the user identifier). The data content of a print job of a print job data set may comprise at least one print job identifier of a selected print job. Preferably, further data may be included, such as the print job category of the print job, the time stamp of the generation of the print job, a title of the print job, etc.

According to a further preferred embodiment of the method according to the invention, the method may further comprise:
displaying the available print jobs of the users on an optical display of the mobile terminal in such a way that the print jobs are selectable (by the user), and
generating, by the mobile terminal, the print data set containing at least one print job of the user selected from the displayed print jobs (upon detection of a selection), and
transmitting the generated print data set to the background system.

In particular, after a receiving of the print job data set by the mobile terminal, the print jobs contained in the print job data set respectively the corresponding print job identifiers can be displayed on an optical display on the mobile terminal. In particular, the at least one print job respectively the at least one print job identifier is displayed on a screen of the mobile terminal in such a way that the print job is selectable by a (manual) user action. Upon detection of a corresponding user action, the mobile terminal generates, in particular, a print data set containing the at least one print job selected by the user from the displayed print jobs. Then (possibly after a further user action) the generated print data set can be transmitted to the background system. In a user-friendly and at the same time secure manner, a print job stored in the background system can be determined for local printing by a local printer.

A further aspect of the invention is a background system for enabling local printing, in particular, during a remote desktop session, wherein the background system comprises at least one print job data memory, wherein at least one user identifier is assigned to at least one of the print jobs stored in the print job data memory, wherein the background system is connectable to at least one local computer comprising at least one local printer, at least one user interface, and a print job router with a unique router identifier, and wherein a TCP/IP-based data connection is establishable between the local computer and the background system via a data network, wherein the background system is configured to store an assignment between an established TCP/IP-based data connection and the router identifier transmitted via the established TCP/IP-based data connection. The background system comprises at least one receiving module configured to receive an authentication data set from a mobile terminal of the user containing at least one user identifier of the user of the mobile terminal. The background system comprises at least one authentication module configured to perform an authentication check at least on the basis of the received user identifier. The receiving module is configured to receive the router identifier from the mobile terminal. The background system comprises at least one transmission module configured to transmit a print job data set containing at least one print job assigned to the received user identifier to the mobile terminal (only) after successful authentication. The receiving module is configured to receive at least one print job to be printed from the mobile terminal and selected from the transmitted print job data set. The transmission module is configured to transmit the at least one print job to be printed via the established TCP/IP-based data connection based on the received router identifier in such a way that the at least one print job to be printed is printable by the local printer.

The background system may comprise at least one data processing device configured to at least partially execute and/or control the method according to the invention or comprising respective means for at least partially executing and/or controlling the method according to the invention. In this case, either all steps of the method according to the invention can be controlled by the means, or all steps of the method according to the invention can be executed by the means, or one or more steps can be controlled by the means and one or more steps can be executed by the means. Different steps can optionally be executed or controlled by different means.

The means respectively modules of the disclosed data processing device may, as has been described, comprise hardware and/or software components. The means may, for example, comprise at least one memory with program instructions of a computer program (e.g., the computer program according to the application) and at least one processor configured to execute program instructions of the at least one memory. Accordingly, the invention is also understood to disclose at least one data processing device comprising at least one processor and at least one memory with program instructions, wherein the at least one memory and the program instructions are configured, together with the at least one processor, to cause the data processing device to execute and/or control the method according to the invention.

A further aspect of the invention is a printing system for local printing. The printing system comprises at least one background system, as has been described above. The printing system comprises at least one (previously described) local computer with at least one local printer and at least one user interface, for example, configured to operate the at least one background application of the background system.

According to a preferred embodiment of the printing system according to the invention, the printing system may further comprise at least one mobile terminal configured to detect a router identifier provided by the local computer and to transmit an authentication data set. In particular, a printing application may be installed on the mobile terminal to control the steps performed by the mobile terminal. An installed printing application in the form of a computer program may, in particular, be executable by the at least one processor of the mobile terminal such that the steps described above are performed by the mobile terminal.

As has already been described, a previously described module, element, etc. may comprise at least partially hardware elements (e.g., processor, storage means, etc.) and/or at least partially software elements (e.g., executable code).

The features of the methods, background systems, and printing systems can be freely combined with each other. In particular, features of the description and/or the dependent claims, even when completely or partially circumventing features of the independent claims, can be independently inventive when used alone or freely combined with each other.

### BRIEF DESCRIPTION OF THE DRAWINGS

There are now a multitude of possibilities for designing and further developing the method, background system, and printing system according to the invention. Reference should be made here to the patent claims subordinate to the independent patent claims on the one hand, and to the description of embodiments in conjunction with the drawing on the other. The drawing shows:

FIG. 1 shows a schematic view of an embodiment of a background system according to the present invention,

FIG. 2 shows a schematic view of an embodiment of a printing system according to the present invention with a further embodiment of a background system according to the present invention, and

FIG. 3 shows a diagram of an embodiment of a method according to the present invention.

### DETAILED DESCRIPTION

Similar reference signs are used below for at least similar elements.

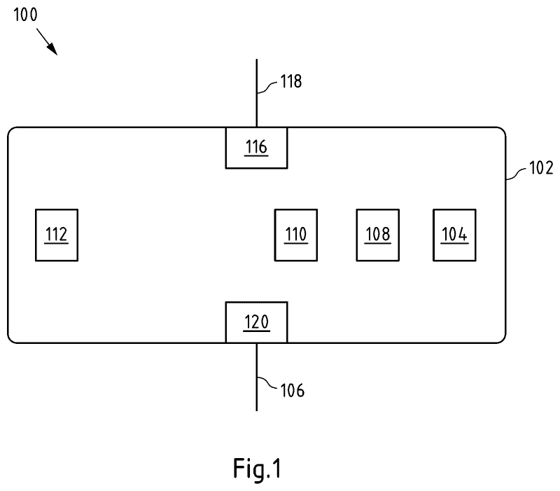

FIG. 1 shows an embodiment of a background system 100 according to the present invention. The background system 100 enables, in particular, the generating of a print job and serves to enable local printing of the print job. The background system 100 comprises at least one data processing device 102 with at least one processor 104.

The background system 100 is connectable with at least one (not shown) local computer, which in turn is connectable with at least one local printer. The local computer comprises a print job router (in the form of a computer program), which, in particular, can be executed by a processor of the local computer. A TCP/IP-based data connection 106 (without a data connection tunnel) can be established between the local computer and the background system 100 respectively is established for local printing (in a known manner). For example, this can enable a background application 108 of the background system 100 (e.g., a word processing program, image processing program, spreadsheet program, printing program, etc.) that can be executed by the processor 104 to be operated by means of at least one user interface of the local computer.

The background system 100, in particular, the data processing device 102, comprises at least one assignment module 110 executable by the processor 104 and configured to assign a TCP/IP-based data connection 106 to a router identifiers of the print job router transmitted via the established TCP/IP-based data connection 106.

At least one print job, in particular, a plurality of print jobs, is stored in a (not shown) print job data memory. At least one user identifier is respectively assigned to at least a part of the stored print jobs, in particular, to all print jobs.

The background system 100 comprises at least one receiving module 116 configured to receive an authentication data set via a further data connection 118 (which differs from the TCP/IP-based data connection 106) from a (not shown) mobile terminal (e.g., a smartphone) of the user containing at least one user identifier. In addition, the authentication data set may contain the aforementioned router identifier. In variants of the invention, the receiving module 116 may also receive the router identifier before or after receiving the authentication data set.

The background system 100 comprises an authentication module 112 (in the form of a computer program) executable, in particular, by the processor 104. The authentication module performs an authentication check at least on the basis of the received user identifier, as has, in particular, been already described. If this shows that the user is an authorized user, local printing can generally be enabled, i.e., if the authentication of the user is successful. If authentication is unsuccessful a print job data set is, in particular, not transmitted.

The background system 100, in particular, the data processing device 102, comprises at least one transmission module 120 configured to transmit a print job data set containing at least one print job assigned to the received user identifier (only) upon a successful authentication. The receiving module 116 is configured to receive at least one print job to be printed from the mobile terminal selected from the transmitted print job data set. The transmission module 112 is configured to transmit the at least one print job to be printed via the established TCP/IP-based data connection 106 based on the received router identifier such that the at least one print job to be printed is printable by the local printer.

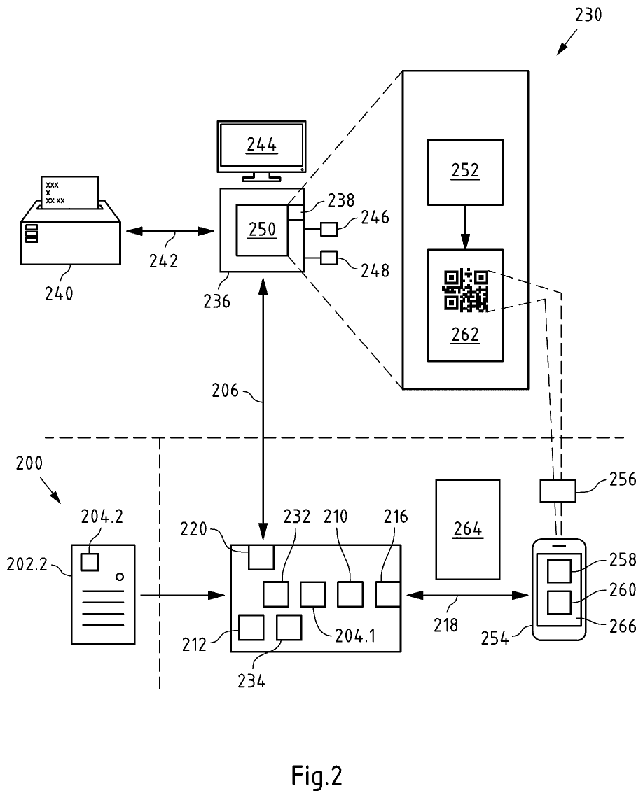

FIG. 2 shows a schematic view of an embodiment of a printing system 230 according to the present invention with a further embodiment of a background system 200 according to the present invention. In order to avoid repetitions, only the differences to the previous embodiment are described below, and otherwise reference is made to the explanations of FIG. 1.

The background system 200 comprises, in the present embodiment, two data processing devices 202.1, 202.2 (each with a processor 204.1, 204.2). A first data processing device 202.1 forms, in particular, a (central) print job management equipment, and the second data processing device 202.2 forms, in particular, a print job memory respectively print job data memory for storing the print jobs generated and, in particular, stored by, for example, a (not shown) background application. The print job memory may be located in a secure network, while the print job management equipment may be located in a public network (e.g., the Internet).

The print job management equipment comprises a previously described receiving module 216, a previously described assignment module 210, a previously described transmission module 220, and a previously described authentication module 212.

Furthermore, the background system 200, in particular, the print job management equipment, may optionally comprise a verification module 234 and a user print authorization database 232 containing a plurality of user identifiers, wherein each user identifier may be assigned at least one user print authorization date relating to the authorization for local printing.

The transmitting of the at least one print job of the user via the established TCP/IP-based data connection 206 may further be based on the at least one user print authorization data assigned to the user identifier of the user. In particular, prior to transmitting the at least one print job, the verification module 234 may verify whether the user is authorized to print this print job locally based on the user authorization date stored in the user print authorization database 232 for the user identifier of the user. Only if by a checking of the user authorization date it is determined that the user is authorized to print the selected print job, the print job is transmitted, as has been described. Otherwise, a transmitting of the print job is blocked respectively not performed.

The printing system 230 comprises at least one local computer 236 with at least one processor 238 (which may, in particular, be located in a home network respectively private network,). In general, a printing system may comprise a plurality of local computers. The at least one (stationary or mobile) local computer 236 comprises at least one (stationary or mobile) local printer 240, which is connected to the local computer 236 via a wired and/or wireless connection 242 (e.g., USB connection, WLAN network, LAN connection, etc.). A local printer 240 is arranged, in particular, adjacent to the local computer 236, for example, in the same room or in an adjacent room. For example, the local printer 240 can be arranged at a maximum distance of 50 m from the local computer 236, in particular, at a maximum distance of 20 m.

A local computer 236, for example, a workstation computer, can have at least one user interface 244, 246, 248. By way of example, presently, a screen 244, a keyboard 246, and a mouse 248 are provided. The local computer 236 comprises a print job router 250 in the form of a computer program (executable by the processor 238 of the local computer 236). The print job router 250 is, in particular, configured to forward respectively route a print job received from the background system 200 to the local printer 240, for example, based on the printer identifier that may be stored in the print job router 250.

In this way, at least one local printer 240 can be selected from a plurality of local printers 240 of the local computer 236 before the router identifier is provided by the local computer 236. If more than one local printer 240 is available, the print job router 250 may, for example, first cause a displaying of a printer list 252 on the screen 244. In particular, the print job router 250 may be configured to detect all local printers 240 of the local computer 236 and, in particular, to generate the printer list 252 based on the detection result. The printer list 252 may contain all available local printers 240 of the local computer 236 respectively their printer identifiers.

A local printer 240 can be selected from the list by means of a user action via a user interface 244, 246, 248. The printer identifier of the selected printer 240 can be stored in the print job router 250. If the local computer 236 receives at least one print job to be printed from the background system 200, the print job to be printed can be forwarded by the print job router 250 to said local printer 240 whose printer identifier is stored.

The print job router 250 can then cause a providing of the router identifier in such a way that a mobile terminal 254 of the user can detect the router identifier.

Preferably, the print job router 250 can generate an optical printer code 262 and, in particular, cause a displaying of the optical printer code 262 on the screen 244. The printer code 262 contains, in particular, the router identifier.

The printing system 230 may preferably comprise the mobile terminal 254 of the user of the local computer 236. In particular, the printing system 230 may comprise a plurality of mobile terminals 254, in particular, of a corresponding plurality of users. In a known manner, the user can be authenticated on the mobile terminal 254 before using the mobile terminal 254. The mobile terminal 254 can be uniquely assigned a user identifier, such as an Apple identifier, a Google identifier, etc. In particular, it is inherent that the mobile terminal 254 can only be used by the authorized user with the user identifier of the mobile terminal 254.

The mobile terminal 254 may comprise a processor 258 and a printing application 260 installed on the mobile terminal 254, which can be executed by the processor 258. In particular, the printing application 260 controls the steps performed by the mobile terminal 254. The mobile terminal 254 comprises an optical detection equipment 256, in particular, in the form of a camera. The printer code 262 can be detected by means of the optical camera. In particular, the printing application 260 can be configured to extract the router identifier from the printer code 262. Subsequently, controlled by the printing application 260, an authentication data set is generated containing at least the user identifier and preferably also the extracted router identifier. A time stamp may also be included. The printing application 260 then causes a transmitting of the authentication data set to the background system 200. In other words, the background system 200 receives the authentication data set from the mobile terminal 254.

As has already been described, an authentication check is performed by the background system 200 based on the user identifier.

In particular, after a successful authentication, a print job data set 264 can be generated by the background system 200, in particular, by the print job management equipment. Preferably, a list of the print jobs currently stored in the print job memory together with the assigned user identifiers can be stored in the print job management equipment. Based on the received user identifier, the print jobs of the corresponding user can be identified. After the print job data set has been generated, it can be transmitted to the mobile terminal 254 that transmitted the authentication data set.

The print application 260 can cause a displaying of the available print jobs on an optical display 266 of the mobile terminal 254 in such a way that a user can select at least one print job by means of a user action. Then, in the manner described above, at least one of the print jobs (there may also be more, for example, all) can be selected by the user. The print application 260 can then cause a transmitting of a print data set containing at least the selected print job, for example, the print job identifier of the at least one selected print job.

Then, a transmitting is performed by the background system of the at least one print job to be printed to the local computer 236 via the established TCP/IP-based data connection 206 based on the received router identifier in such a way that the at least one print job to be printed is printable by the local printer 240. In particular, the assigned TCP/IP-based data connection 206 is determined on the basis of the router identifier received via the mobile terminal 236, and the at least one print job is transmitted via this connection.

Upon receipt of the print job, the print job router 250 forwards the print job to the local printer 240, whose printer identifier is stored, for example, in the print job router 250. Then, a printing of the print job can be performed by the local printer 240 in the conventional manner.

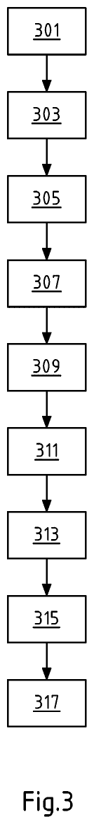

FIG. 3 shows a diagram of an embodiment of a (computer-implemented) method. The method is used for local printing of a print job, in particular, during an established TCP/IP-based data connection (without a tunnel). In particular, the method can be used to operate a printing system according to FIG. 2.

In step 301, a providing of at least one local computer is performed comprising at least one local printer, at least one user interface, and a print job router with a unique router identifier, as has, in particular, been described above.

In step 303, a providing of a background system is performed comprising at least one print job data memory respectively a print job memory, wherein at least a part of the print jobs stored in the print job data memory are each assigned a user identifier, as has, in particular, been described above.

In step 305, an establishing of a TCP/IP-based data connection is performed between the local computer and the background system via a (public) data network (in particular, the Internet), wherein the background system is configured to store an assignment between the established TCP/IP-based data connection and the router identifier transmitted via the established TCP/IP-based data connection, as has, in particular, been described above.

In a further step 307, a providing, by the print job router, is performed of at least the router identifier in such a way that at least the router identifier is detectable by a mobile terminal of the user, as has, in particular, been described above. For example, step 307 can be initiated by the user after a print job is generated by a user action.

In step 309, a receiving, by the background system, is performed of an authentication data set from the mobile terminal containing at least one user identifier of the user of the mobile terminal, as has, in particular, been described above. Preferably, the authentication data set may also contain the router identifier detected by the mobile terminal. Alternatively, a separate reception step may be performed.

In step 311, the background system performs an authentication check at least on the basis of the received user identifier, as described in particular above.

In step 313, a transmitting, by the background system, is performed of a print job data set containing at least one print job assigned to the received user identifier to the mobile terminal (only) after successful authentication.

In step 315, a receiving, by the background system, is performed of at least one print job to be printed from the mobile terminal selected from the transmitted print job data set, as has, in particular been already described.

In step 317, a transmitting, by the background system, is performed of the at least one print job to be printed to the local computer via the established TCP/IP-based data connection based on the received router identifier in such a way that the at least one print job to be printed is printable by the local printer, as has, in particular, been already described.

It shall be understood that the aforementioned steps can be performed at least partially in parallel (e.g., steps 301 and 303).

### REFERENCE SIGN LIST

100 background system
102 data processing device
104 processor
106 data connection
108 background application
110 assignment module
112 authentication module
116 receiving module
118 data connection
120 transmission module
200 background system
202 data processing device
204 processor
206 data connection
210 assignment module
212 authentication module
216 receiving module
220 transmission module
230 printing system
232 user printing authorization database
234 verification module
236 local computer
238 processor
240 local printer
242 connection
244 user interface
246 keyboard
248 mouse
250 print job router
252 printer list
254 mobile terminal device
256 optical detection equipment
258 processor
260 printing application
262 printer code
264 job data set
266 optical display
301 step
303 step
305 step
307 step
309 step
311 step
313 step
315 step
317 step

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for local printing, comprising:
providing at least one local computer comprising at least one local printer, at least one user interface, and a print job router with a unique router identifier,
providing a background system comprising at least one print job data memory, wherein at least a part of the print jobs stored in the print job data memory are each assigned a user identifier,
establishing a TCP/IP-based data connection between the local computer and the background system via a data network, wherein the background system is configured to store an assignment between the established TCP/IP-based data connection and the router identifier transmitted via the established TCP/IP-based data connection,
providing, by the local computer, of at least the router identifier such that at least the router identifier is detectable by a mobile terminal of a user,
receiving, by the background system, an authentication data set from the mobile terminal containing at least a user identifier of the user of the mobile terminal,
performing, by the background system, an authentication check at least on the basis of the received user identifier,
receiving, by the background system from the mobile terminal, at least the router identifier,
transmitting, by the background system to the mobile terminal, a print job data set containing at least one print job assigned to the received user identifier after a successful authentication,
receiving, by the background system from the mobile terminal, at least one print job to be printed selected from the transmitted print job data set, and
transmitting, by the background system to the local computer, of the at least one print job to be printed via the established TCP/IP-based data connection based on the received router identifier such that the at least one print job to be printed is printable by the local printer.

2. The method according to claim 1, wherein
the providing, by the local computer, of at least the router identifier comprises causing a displaying of an optical printer code containing at least the router identifier by an optical display of the local computer.

3. The method according to claim 2, wherein
the optical printer code is a barcode.

4. The method according to claim 1, wherein
prior to the providing of the router identifier by the local computer, at least one local printer is selected from a plurality of local printers of the local computer,
the printer identifier of the selected printer is stored in the print job router, and
upon receipt of the at least one print job to be printed by the local computer, the print job to be printed is routed by the print job router to the local printer whose printer identifier is stored.

5. The method according to claim 1, wherein
the print jobs are stored in the print job data memory of the background system, which can be accessed by a print job management equipment of the background system,
wherein a list containing at least the print job identifiers of the print jobs stored in the print job memory is stored in the print job management equipment.

6. The method according to claim 1, wherein the method further comprises:
restricting an access to the background system, at least to the print job data memory, by at least one security module implemented in the background system, and/or
restricting an access to the local computer by at least one security module implemented in the local computer.

7. The method according to claim 1, wherein
the at least one print job of the user is generated by the at least one background application,
wherein generating the print job comprises assigning a print job identifier and the user identifier to the print job.

8. The method according to claim 1, wherein the method further comprises:
providing a user print authorization database containing at least a plurality of user identifiers, wherein each user identifier is assigned at least one user print authorization date regarding the authorization for local printing, and
wherein transmitting the at least one print job of the user via the established data connection is further based on the at least one user print authorization date assigned to the user identifier of the user.

9. A background system for enabling local printing, wherein the background system comprises at least one print job data memory, wherein at least a part of the print jobs stored in the print job data memory are each assigned a user identifier, wherein the background system is connectable to at least one local computer comprising at least one local printer, at least one user interface, and a print job router with a unique router identifier, and wherein a TCP/IP-based data connection is establishable between the local computer and the background system via a data network, wherein the background system is configured to store an assignment between an established TCP/IP-based data connection and a user identifier transmitted via the established TCP/IP-based data connection, comprising:
at least one receiving module configured to receive an authentication data set from a mobile terminal of the user containing at least one user identifier of the user of the mobile terminal,
at least one authentication module configured to perform an authentication check based at least on the received user identifier,
wherein the receiving module is configured to receive the router identifier from the mobile terminal, and
at least one transmission module configured to transmit to the mobile terminal a print job data set containing at least one print job assigned to the received user identifier after a successful authentication,
wherein the receiving module is configured to receive at least one print job to be printed from the mobile terminal selected from the transmitted print job data set, and
wherein the transmission module is configured to transmit the at least one print job to be printed via the established TCP/IP-based data connection based on the received router identifier such that the at least one print job to be printed is printable by the local printer.

10. A printing system for local printing, comprising:
at least one background system according to claim 9, and
at least one local computer comprising at least one local printer, at least one user interface, and a print job router with a unique router identifier.

11. The printing system according to claim 10, wherein the printing system further comprises:
at least one mobile terminal configured to detect a router identifier provided by the local computer and to transmit an authentication data set.

12. The method according to claim 1, wherein
the method serves for local printing during a remote desktop session.

13. The method according to claim 3, wherein
the barcode is a QR barcode and/or 2D barcode.

14. The method according to claim 7, wherein
the at least one background application is a web printing application.

15. The background system according to claim 9, wherein
the background systems serves for enabling local printing during a remote desktop session.
